(19) United States
(12) Patent Application Publication
(10) Pub. No.: US 2026/0155694 A1
(43) Pub. Date: Jun. 4, 2026

(54) STATOR AND ELECTRICAL MACHINE

(71) Applicant: Dr. Ing. h.c. F. Porsche Aktiengesellschaft, Stuttgart (DE)

(72) Inventor: RAPHAEL OESTREICHER, Waiblingen (DE)

(21) Appl. No.: 19/403,047

(22) Filed: Nov. 27, 2025

(30) Foreign Application Priority Data
Dec. 4, 2024 (DE) 10 2024 136 027.5

(51) Int. Cl. H02K 3/28; H02P 25/18

(52) U.S. Cl. CPC H02K 3/28; H02P 25/184; H02K 2203/15

(57) ABSTRACT

A stator is for an electrical machine. The stator includes: a stator body with stator grooves; a winding system with winding cables, at least two of the winding cables being arranged in each of the stator grooves; phase pins configured so as to be connected to different electrical phases of a power supply; and a switching device, via which at least one of the winding cables per each of the stator grooves is selectively connectable to two different phase pins such that, in a first switching state of the switching device, the winding cables arranged in the same stator groove are all connected to the same phase pin, and, in a second switching state of the switching device, the winding cables arranged in the same stator groove are connected to at least two different phase pins.

### CROSS REFERENCE TO RELATED APPLICATIONS

This application claims benefit to German Patent Application No. DE 10 2024 136 027.5, filed on Dec. 4, 2024, which is hereby incorporated by reference herein.

### FIELD

The present disclosure relates to a stator for an electrical machine. The present disclosure further relates to an electrical machine having such a stator.

### SUMMARY

In an embodiment, the present disclosure provides a stator for an electrical machine. The stator includes: a stator body having stator grooves; a winding system having winding cables, with at least two of the winding cables being arranged in each of the stator grooves; phase pins, which are configured so as to be connected to different electrical phases of a power supply; and a switching device, via which at least one of the winding cables per each of the stator grooves is selectively connectable to two different phase pins of the plurality of phase pins such that, in a first switching state of the switching device, the winding cables arranged in the same stator groove are all connected to the same phase pin, and, in a second switching state of the switching device, the winding cables arranged in the same stator groove are connected to at least two different phase pins.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of an electrical machine according to the present disclosure, having a stator according to the present disclosure;

FIG. 2 shows, schematically, an arrangement of winding cables of a winding system within stator grooves of a pole of a stator body of the stator of FIG. 1; and

FIG. 3 shows a simplified circuit diagram for the stator of FIG. 1.

### DETAILED DESCRIPTION

Aspects of the present disclosure enable the realization of an efficient electrical machine.

A stator implemented according to an aspect of the present disclosure comprises a magnetizable, preferably ferromagnetic, stator body having a plurality of stator grooves. The stator body is preferably formed by one or more sheet metal packets but can in principle also be configured as a monolithic body. The stator grooves are typically configured substantially identically and are evenly distributed along a perimeter of the stator body.

A stator according to an aspect of the present further comprises a multilayer winding system configured e.g., as a winding system having a plurality of winding cables arranged in the stator grooves of the stator body such that at least two winding cables are arranged in each stator groove of the stator body. Preferably, the winding cables are all electrically connected to a common star point via one of their two ends.

A stator according to an aspect of the present disclosure may further include a plurality of, preferably three, phase pins that are configured so as to be connected to different electrical phases of a multi-phase power supply device, for example a three-phase alternating voltage network or a multi-phase inverter.

A stator according to an aspect of the present disclosure may further include a switching device comprising a plurality of switches, via which at least one winding cable per stator groove, i.e., per stator groove of at least one of the winding cables arranged in the respective stator groove, can selectively be connected to two different phase pins. The switching device is configured such that, in a first switching state of the switching device, the winding cables arranged in the same stator groove are all connected to the same phase pin and, in a second switching state of the switching device, the winding cables arranged in the same stator groove are connected to at least two different phase pins. The first switching state of the switching device consequently allows for the realization of a so-called uncorded winding system, and the second switching state of the switching device consequently allows for the realization of a winding system that has a so-called cording. Preferably, the switching device comprises two switches for each winding cable that is connectable to different phase pins.

A switching device according to aspects of the present disclosure allows for the winding system to be operated selectively as an uncorded winding system or as a winding system having a cording, so that a particularly efficient electrical machine can be realized with the stator according to the invention.

The switching device can comprise any type of switches that are suitable for switching electrical currents. In a preferred implementation, the switching device comprises a plurality of electronically controllable semiconductor switches. Particularly preferably, the switching device comprises a plurality of MOSFETs.

An electrical machine according to an aspect of the present disclosure includes a stator according of the present disclosure and a control unit configured so as to switch the switching device between the first switching state and the second switching state. The control unit may include a microcontroller or another type of processor or computing device. Furthermore, the control unit may include a driver circuit configured for driving semiconductor switches of the switching device.

The electrical machine according to implementation of the present disclosure can be realized particularly efficiently by using the stator according to the present disclosure for the aforementioned reasons.

Preferably, the control unit is configured so as to detect at least one present operating parameter of the electrical machine by means of a suitable detection device and/or to receive it from a suitably configured detection unit, as well as to select a respective switching state of the switching device to be set based on at least one present operating parameter of the electrical machine. The control unit is thus preferably configured so as to select, based on the at least one present operating parameter, whether the winding system of the stator is to be operated as an uncorded winding system or as a winding system having a cording. This enables the realization of a particularly efficient electrical machine. Preferably, the control unit is configured so as to select the respective switching state of the switching device to be set based on a plurality of present operating parameters of the electrical machine. For example, the at least one operating parameter of the electrical machine can comprise a present torque and/or a present rotational speed of the electrical machine.

Particularly preferably, the control unit comprises a characteristic map for selecting the switching state of the switching device to be set, in which the switching state of the switching device to be set is respectively stored for different values of the at least one present operating parameter. This enables the simple realization of a selection of the switching state of the switching device to be set in an operation parameter-dependent manner.

An exemplary embodiment implemented according to aspects of the present disclosure is described below with reference to the attached figures.

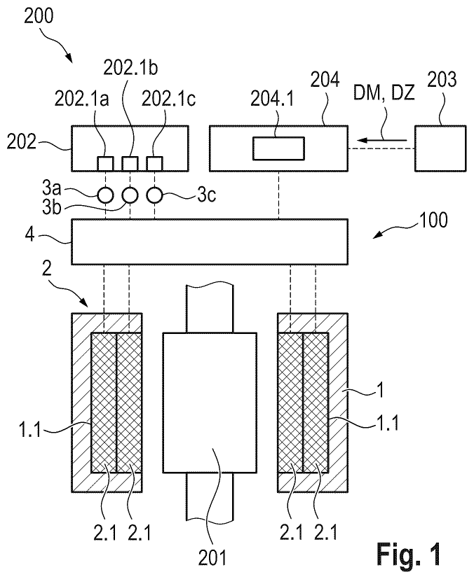

FIG. 1 shows an electrical machine 200 implemented according to aspects of the present disclosure, having a stator 100 implemented according to aspects of the present disclosure, a rotor 201 cooperating with the stator, a power supply device (also referred to herein as a power supply) 202, a detection device 203, and a control unit (also referred to herein as a controller) 204.

In the present exemplary embodiment, the power supply device 202 is a three-phase inverter configured so as to provide an alternating voltage comprising three electrical phases 202.1.

The detection device 203 is configured so as to detect or calculate as present operating parameters of electrical machine 200, a present rotational speed DZ, as well as a present torque DM of electrical machine 200.

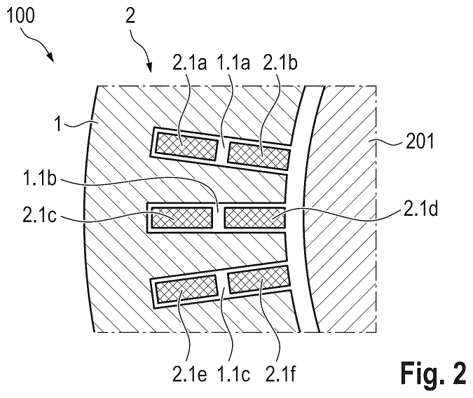

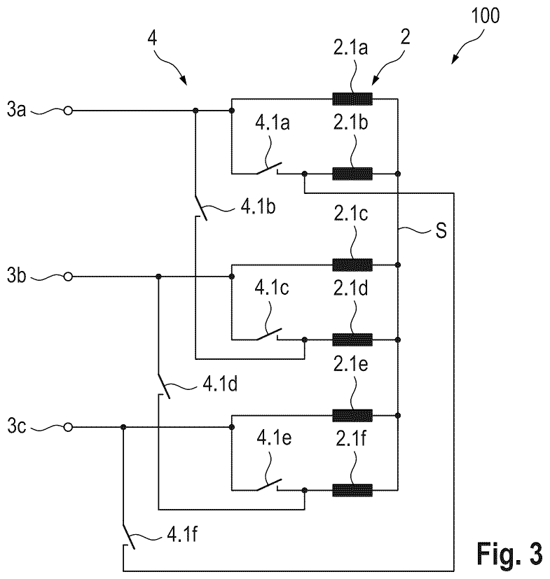

FIG. 2 shows by way of example an excerpt of a pole of the stator 100, and FIG. 3 shows a simplified circuit diagram of the stator 100.

The stator 100 comprises a ferromagnetic stator body 1 having a plurality of stator grooves 1.1, wherein, in the present exemplary embodiment, each pole of the stator 100 comprises three respective stator grooves 1.1.

The stator 100 further comprises a winding system 2 having a plurality of winding cables 2.1, wherein all winding cables 2.1 are electrically connected via one of their ends to a common star point S.

In the present exemplary embodiment, a first winding cable 2.1a and a second winding cable 2.1b are arranged in a first stator groove 1.1a of each pole, a third winding cable 2.1c and a fourth winding cable 2.1d are arranged in a second stator groove 1.1b of each pole, and a fifth winding cable 2.1e and a sixth winding cable 2.1f are arranged in a third stator groove 1.1c of each pole.

The stator 100 further comprises three phase pins 3, wherein a first phase pin 3a is electrically connected to a first electrical phase 202.1a of the power supply device 202, wherein a second phase pin 3b is electrically connected to a second electrical phase 202.1b of the power supply device 202, and wherein a third phase pin 3c is electrically connected to a third electrical phase 202.1c of the power supply device 202.

The first phase pin 3a is additionally electrically connected to the first winding cable 2.1a, the second phase pin 3b is additionally electrically connected to the third winding cable 2.1c, and the third phase pin 3c is additionally electrically connected to the fifth winding cable 2.1e.

The stator 100 further comprises a switching device 4, which in the present embodiment comprises six semiconductor switches 4.1 configured as MOSFETs, wherein a first semiconductor switch 4.1a is arranged between the first phase pin 3a and the second winding cable 2.1b, wherein a second semiconductor switch 4.1b is arranged between the first phase pin 3a and the fourth winding cable 2.1d, wherein a third semiconductor switch 4.1c is arranged between the second phase pin 3b and the fourth winding cable 2.1d, wherein a fourth semiconductor switch 4.1d is arranged between the second phase pin 3b and the sixth winding cable 2.1f, wherein a fifth semiconductor switch 4.1e is arranged between the third phase pin 3c and the sixth winding cable 2.1f, and wherein a sixth semiconductor switch 4.1f is arranged between the third phase pin 3c and the second winding cable 2.1b.

The switching device 4 is configured in this case so as selectively realize a first switching state or a second switching state, wherein, in the first switching state, the second winding cable 2.1b is electrically connected to the first phase pin 3a via the first semiconductor switch 4.1a, the fourth winding cable 2.1d is electrically connected to the second phase pin 3b via the third semiconductor switch 4.1c, and the sixth winding cable 2.1f is electrically connected to the third phase pin 3c via the fifth semiconductor switch 4.1e, and wherein, in the second switching state, the second winding cable 2.1b is electrically connected to the third phase pin 3c via the sixth semiconductor switch 4.1f, the fourth winding cable 2.1d is electrically connected to the first phase pin 3a via the second semiconductor switch 4.1b, and the sixth winding cable 2.1f is electrically connected to the second phase pin 3b via the fourth semiconductor switch 4.1d.

Consequently, in the first switching state of the switching device 4, the two winding cables 2.1 arranged in the same stator groove 1.1 are each electrically connected to the same phase pin 3 and, in the second switching state of the switching device 4, the two winding cables 2.1 arranged in the same stator groove 1.1 are each electrically connected to two different phase pins 3.

During operation, the present operating parameters, i.e., the present rotational speed DZ and the present torque DM, of the electrical machine 200 are provided to the control unit 204 by the detection device 203.

The control unit 204 comprises a characteristic map 204.1 in which a switching state to be set by the switching device 4 is stored for different combinations of the present rotational speed DZ and the present torque DM, i.e., in each case it is stored whether the first switching state or the second switching state of the switching device 4 is to be set.

The control unit 204 is configured so as to switch the switching device 4 between the first switching state and the second switching state by suitably driving the semiconductor switches 4.1.

Specifically, the control unit 204 is configured so as to select the switching state to be set using the characteristic map 204.1 based on the present operating parameters of the electrical machine 200 provided by the detection device 203, i.e., based on the present rotational speed DZ and the present torque DM of the electrical machine 200, and to drive the semiconductor switches 4.1 of the switching device 4 such that the respective switching state to be set is realized.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

200 Electrical machine
201 Rotor
202 Power supply device
202.1 Electrical phases
203 Detection device
204 Control unit
204.1 Characteristic map
100 Stator
1 Stator body
1.1 Stator grooves
2 Winding system
2.1 Winding cables
3 Phase pins
4 Switching device
4.1 Semiconductor switch
DM Present torque
DZ Present rotational speed
S Star point

1. A stator for an electrical machine, the stator comprising:
a stator body comprising a plurality of stator grooves;
a winding system comprising a plurality of winding cables, wherein at least two of the winding cables are arranged in each of the stator grooves;
a plurality of phase pins, which are configured so as to be connected to different electrical phases of a power supply; and
a switching device, via which at least one of the winding cables per each of the stator grooves is selectively connectable to two different phase pins of the plurality of phase pins such that, in a first switching state of the switching device, the winding cables arranged in the same stator groove are all connected to the same phase pin, and, in a second switching state of the switching device, the winding cables arranged in the same stator groove are connected to at least two different phase pins.

2. The stator according to claim 1, wherein the switching device comprises a plurality of semiconductor switches.

3. The electrical machine comprising:
the stator according to claim 1; and
a controller configured so as to switch the switching device between the first switching state and the second switching state.

4. The electrical machine according to claim 3, wherein the controller is configured so as to select a respective switching state of the switching device to be set based on at least one present operating parameter of the electrical machine, the respective switching state being selected from the group consisting of the first switching state and the second switching state.

5. The electrical machine according to claim 4, wherein the controller comprises a characteristic map for selecting the respective switching state of the switching device to be set.
